(19) United States
(12) Patent Application Publication
(10) Pub. No.: US 2014/0299006 A1
(43) Pub. Date: Oct. 9, 2014

(54) SOYMILK MAKER

(71) Applicants: Marcel Johan Dalitso Fleuren, Delft (NL); Fei Xue, Shanghai (CN); Donghai Yu, Shanghai (CN); Xiaoyun Kui, Shanghai (CN); Changjie Wang, Shanghai (CN); Qi Zhou, Shanghai (CN)

(72) Inventors: Marcel Johan Dalitso Fleuren, Delft (NL); Fei Xue, Shanghai (CN); Donghai Yu, Shanghai (CN); Xiaoyun Kui, Shanghai (CN); Changjie Wang, Shanghai (CN); Qi Zhou, Shanghai (CN)

(73) Assignee: KONINKLIJKE PHILIPS N.V., EINDHOVEN (NL)

(21) Appl. No.: 14/113,478

(22) PCT Filed: May 3, 2012
(86) PCT No.: PCT/IB12/52210

§ 371 Date: Oct. 23, 2013

(30) Foreign Application Priority Data
May 10, 2011 (CN) 2001/073893

(51) Int. Cl. A23N 1/02

(52) U.S. Cl. CPC A23N 1/02
USPC 99/513; 99/510

(57) ABSTRACT

The invention proposes a soymilk maker and a method of making soymilk, using the soymilk maker. The soymilk maker comprises a container for receiving the bean or soymilk; a machine head arranged on the upper portion of the container, the machine head having a motor accommodated therein; a rotary cutter driven by the motor; a collection unit arranged within the container for collecting the testa and residue; an adjusting mechanism arranged on the machine head and being adjustable to enable the collection unit to move within the container between a first position where the beans are processed and a second position where the testa or residue is collected in the collection unit. Such a configuration enables testa and residue to be collected in the collection unit without said unit being equipped with a separate filter and a separate cup.

### FIELD OF THE INVENTION

The present invention relates to the field of soymilk makers, more particularly to a home soymilk maker.

### BACKGROUND OF THE INVENTION

Soymilk makers, particularly home soymilk makers are getting more and more popular nowadays. Most soymilk makers available in the market cannot directly output soymilk without residue.

As disclosed in Chinese patent publication number CN101632430A, this kind of soymilk maker comprises a machine head, a motor arranged in the machine head, a control device, a soymilk container, a crushing device arranged on an output shaft of the motor, a heating device and a base. The existing home soymilk making process basically comprises the following steps: soaking the beans manually by the consumer, such as putting the dry beans into water and allowing them to soak at room temperature overnight; blending/cooking the beans, which is automatically controlled by the soymilk maker; filtering the residue manually by the consumer to obtain the soymilk.

Consequently, this kind of soymilk maker should be equipped with a separate filter and a separate cup for filtering the soymilk, since residue remaining in soymilk will impact the taste and flavor of the soymilk. One problem is that the residue must be filtered manually by consumers. Another problem is that the additional filter and cup will occupy more space, which brings inconvenience to the user.

### SUMMARY OF THE INVENTION

It would be advantageous to achieve a soymilk maker having a collection unit for collecting testa and residue. It would also be desirable to enable the soymilk maker to collect the testa after the dehulling process and to collect the residue after the soymilk making process, using the same collection unit.

To this end, in a first aspect of the invention, there is provided a soymilk maker comprising: a container; a machine head arranged on the upper portion of the container having a motor accommodated therein; a rotary cutter driven by the motor; a collection unit arranged within the container for collecting testa and residue; an adjusting mechanism arranged on the machine head and being adjustable to enable the collection unit to move within the container between a first position where the beans are processed and a second position where testa and residue are collected in the collection unit.

In this aspect, testa and residue can be collected in the collection unit and stored there temporarily, and the soymilk is then obtained and preserved in the container, ready to be consumed directly by people.

In one preferred embodiment, the collection unit of the soymilk maker comprises a collection basket and a guide cup concentrically arranged at the bottom of the collection basket.

In this preferred embodiment, the guide cup can agitate the water-bean mixture in the container so as to form a stream passing through the collection basket above the guide cup, as a result of which, testa and residue are trapped in the collection basket.

In another preferred embodiment, the soymilk maker comprises a connector passing through the machine head and connecting the collection basket to the adjusting mechanism for suspending the collection basket within the container.

In this preferred embodiment, the collection basket of the collection unit of the soymilk maker is suspended within the container and connected to the adjusting mechanism by means of the connector, so that the collection unit can easily move within the container between the first position and the second position by operating the adjusting mechanism.

In still another preferred embodiment, the adjusting mechanism comprises a threaded rod attached to the machine head and extending upwards, a nut engaging with the threaded rod, and a hand lever detachably mounted on the nut and linked with the connector.

In this preferred embodiment, the soymilk maker comprises an adjusting mechanism enabling the collection unit to move between the first position and the second position when the hand lever of the adjusting mechanism moves up and down as the nut is turned up and down. This kind of adjusting mechanism has a simple structure and can be operated easily.

In yet another preferred embodiment, the guide cup of the collection unit of the soymilk maker extends a first distance above the bottom surface of the collection basket of the collection unit, so that a collection chamber is formed between the guide cup and the collection basket.

In this preferred embodiment, a collection chamber is formed between the guide cup and the collection basket of the collection unit, so that testa and residue are collected therein.

In still another preferred embodiment, the upper end of the guide cup abuts against the lower end of the machine head when the collection unit is in the first position.

In this preferred embodiment, the collection chamber is arranged so as to prevent the testa and residue trapped therein from being in communication with the water-bean mixture in the container via the guide cup.

In yet a further preferred embodiment, the upper end of the collection basket is an interference fit with the machine head, so that the testa or residue in the collection chamber is prevented from spilling out and the contents in the container is prevented from entering into the collection unit via the upper end of the collection basket.

In a second aspect of the invention, there is provided a method of making soymilk using the soymilk maker, comprising the steps of: grinding at a first speed to separate the testa from the beans when the collection unit is held in the first position; grinding at a second speed to collect the testa when the collection unit is adjusted to, and held in, the second position; grinding at a third speed when the collection unit is adjusted to, and held in, the first position; grinding at a fourth speed to collect the residue when the collection unit is adjusted to, and held in, the second position.

In this aspect, the testa is collected after grinding at a first speed, i.e., before the dehulling process, and before grinding at a third speed, i.e., before grinding thoroughly to make soymilk. The residue is collected after grinding at a third speed, i.e., after the soymilk making process. Adding the step of dehulling the beans and collecting the testa will improve residue reduction during the soymilk making process and extract more nutrition into the soymilk. Both (?) in the step of collecting testa and in the step of collecting residue, the collection unit is adjusted to, and held in, the second position.

In one preferred embodiment, the second speed is lower than the first speed, the first speed is lower than the third speed, and the fourth speed is equal to the second speed, wherein the first speed is a medium speed in the range of 1000˜4000 r/min, the second speed is a low speed in the range of 300˜800 r/min, and the third speed is a high speed which is higher than 10,000 r/min.

In this preferred embodiment, the beans can be satisfactorily dehulled at a medium speed, the testa and residue can be effectively collected at a low speed, and the soymilk is made at a high speed.

In another preferred embodiment, the method further comprises, before the step of grinding at a first speed to separate the testa from the beans, the steps of: adjusting the adjusting mechanism, causing the collection unit of the soymilk maker to be held in the first position.

In still another preferred embodiment, the method further comprises the step of adjusting the adjusting mechanism, causing the collection unit to be held in the first position, so that the milk is ready for consumption.

In yet another preferred embodiment, the method further comprises, before the step of grinding at a first speed to separate the testa from the beans when the collection unit is held in the first position, a step of soaking the beans in water at about 90 for about 4 minutes.

These and other aspects of the present invention will be apparent from and elucidated with reference to the embodiments described hereinafter.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements, in which:

FIG. 1a is a top perspective view of a soymilk maker according to one embodiment of the invention, wherein a collection unit of the soymilk maker is in a first position;

FIG. 1b is a side view of the soymilk maker of FIG. 1a;

FIG. 1c is a cross-sectional view of the soymilk maker of FIG. 1a;

FIG. 2a is another top perspective view of the soymilk maker according to the embodiment of the invention, wherein the collection unit of the soymilk maker is in a second position;

FIG. 2b is a side view of the soymilk maker of FIG. 2a;

FIG. 2c is a cross-sectional view of the soymilk maker of FIG. 2a;

FIG. 3a is a top perspective view of a portion of the soymilk maker of FIG. 1a, showing an adjusting mechanism and a collection unit of the soymilk maker, in which figure at least a container of the soymilk maker has been omitted for clarity;

FIG. 3b is an exploded perspective view of the portion of the soymilk maker of FIG. 3a;

FIG. 4a is a perspective view of the portion of the soymilk maker of FIG. 3a, showing the adjusting mechanism mounted thereon and being in its first position, while the collection unit has been omitted for clarity;

FIG. 4b is a side view of the portion of the soymilk maker of FIG. 4a, showing the adjusting mechanism in its first position;

FIG. 4c is a top view of FIG. 4b;

FIG. 4d is an enlarged perspective view of a nut of the adjusting mechanism of FIG. 4a;

FIG. 5a is a perspective view of the collection unit of the soymilk maker of FIG. 3a;

FIG. 5b is a side view of the collection unit of FIG. 5a;

FIG. 5c is a top plan view of the collection unit of FIG. 5a;

FIG. 6a is a cross-sectional view similar to FIG. 1c, showing the details within the soymilk maker, wherein the collection unit is in the first position;

FIG. 6b is a cross-sectional view similar to FIG. 2c, showing the details within the soymilk maker, wherein the collection unit is in the second position;

FIG. 6c is a partial view on an enlarged scale of FIG. 6b.

### DETAILED DESCRIPTION OF EMBODIMENTS

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

The directional terms, such as upper, lower, vertical, horizontal and the like as used herein, do not denote a specific desired orientation and instead are used for ease of describing the present invention.

The term “beans” used in this invention is a generalized concept and could correspond to soybeans, mung beans, cowpea, etc., and the term “cotyledon(s)” means the beans without the hulls, which can also be referred to as “inner parts of the beans” or “dehulled beans”.

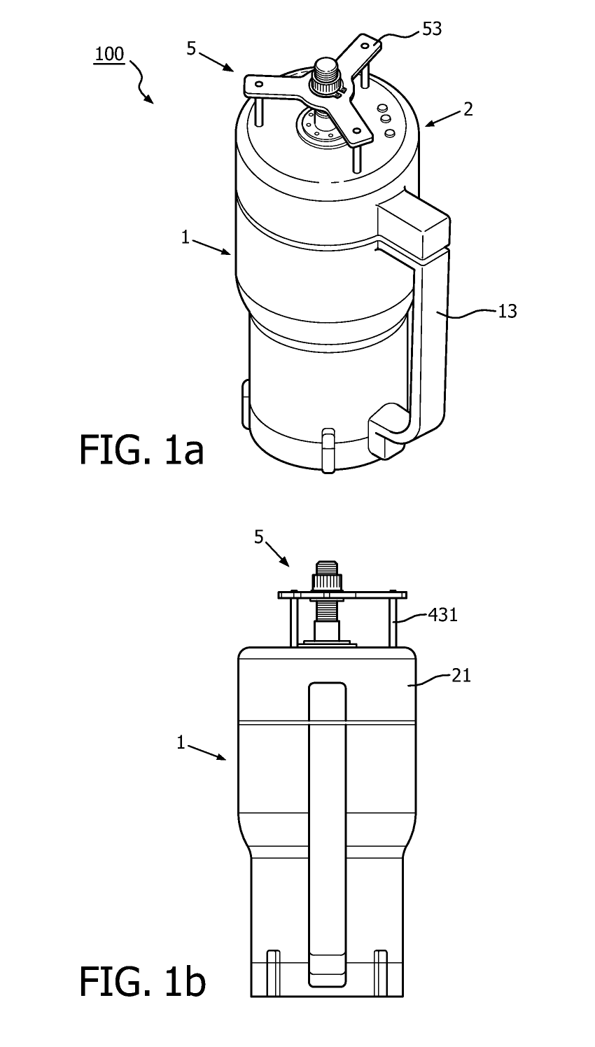

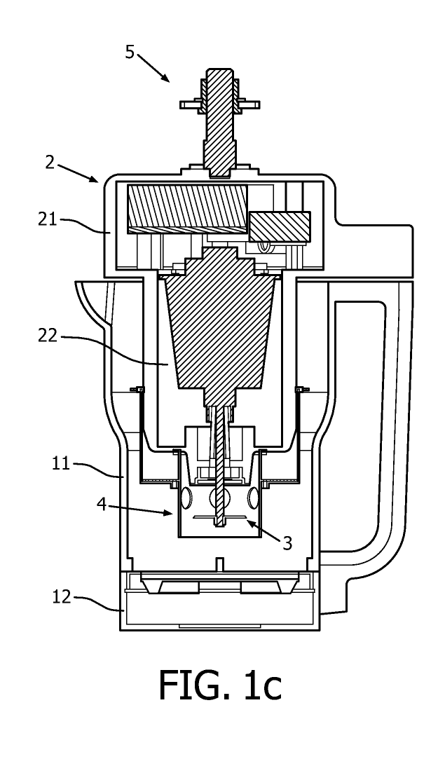

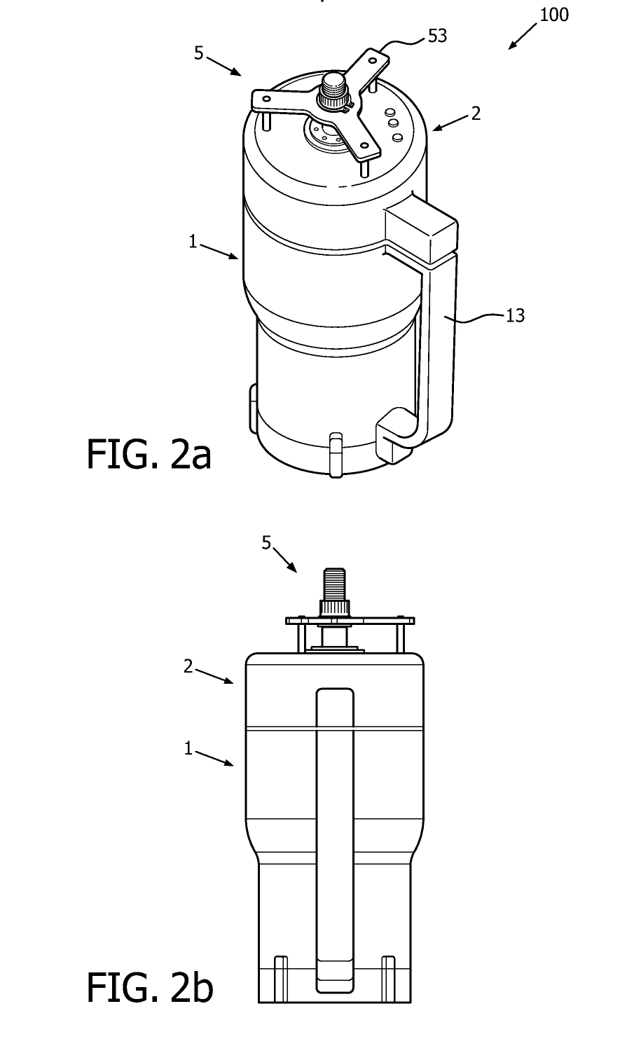

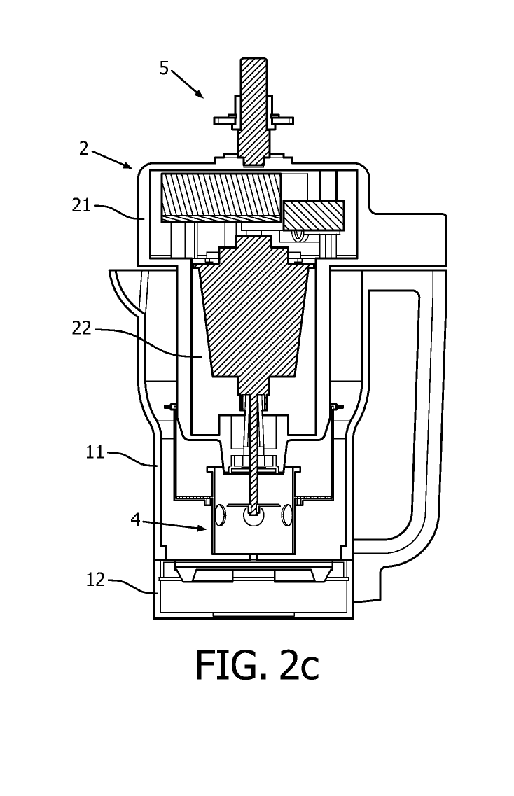

Referring now to FIGS. 1a-3b of the drawings, a soymilk maker according to a preferred embodiment of the invention is shown. The soymilk maker 100 comprises a container 1 for receiving beans or soymilk, a machine head 2 arranged on the upper portion of the container 1 and having a motor accommodated therein (not shown), a rotary cutter 3 driven by the motor, a collection unit 4 arranged within the container 1 for collecting testa and residue, and an adjusting mechanism 5 arranged on the machine head, said adjusting mechanism being adjusted to enable the collection unit 4 to move within the container 1 between a first position (see FIG. 1c) and a second position (see FIG. 2c).

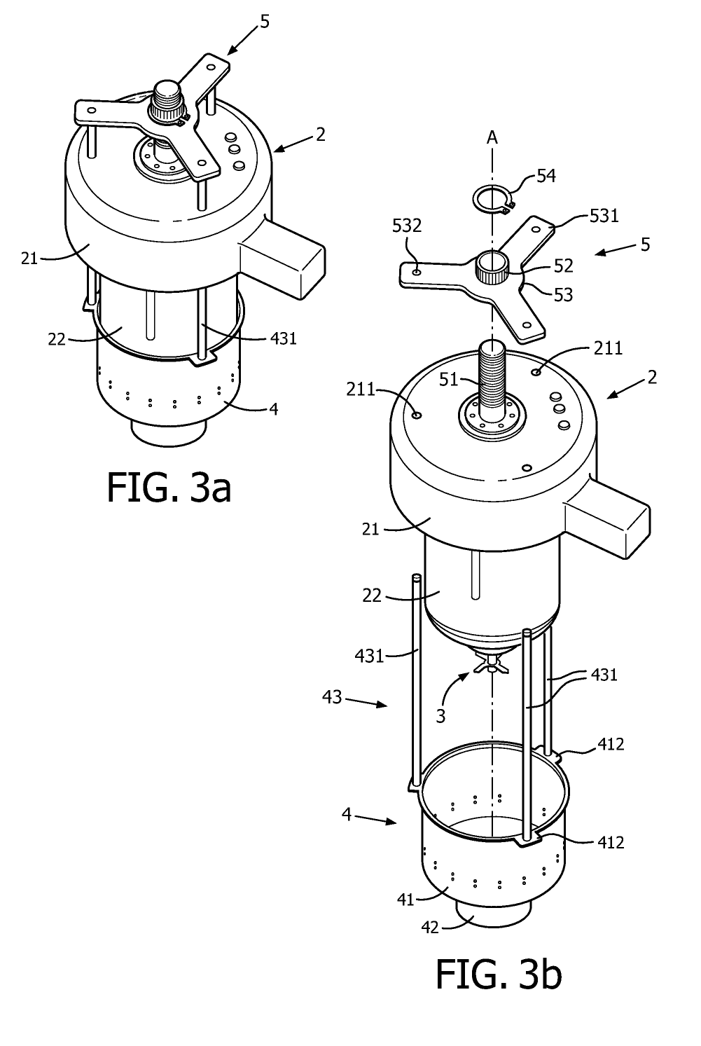

As shown in FIG. 1a or FIG. 2a, the container 1 has a body 11 and a base 12 on which the body 11 is seated in place. A heating device (not shown) such as a heating tube is provided in the base 12, which is used for heating the beans or soymilk in the body 11 of the container 1. Alternatively, the heating tube may be connected to rotary cutter 3 (see FIG. 3b). For ease of use, the container 1 further has a hand grip 13.

Referring to FIGS. 3a and 3b, the machine head 2 comprises a head cover 21 for covering the container 1 and a head body 22 containing the motor. On the head cover 21, the adjusting mechanism 5 is arranged along the longitudinal axis A. The rotary cutter 3 is attached to the output shaft of the motor and extends vertically downward, so that it can be rotated by the motor.

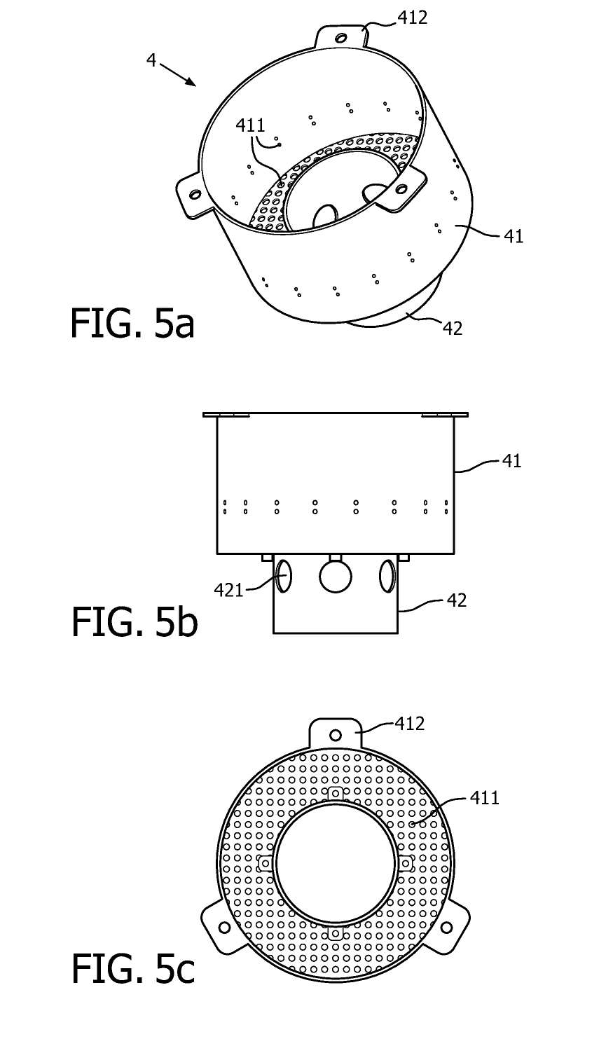

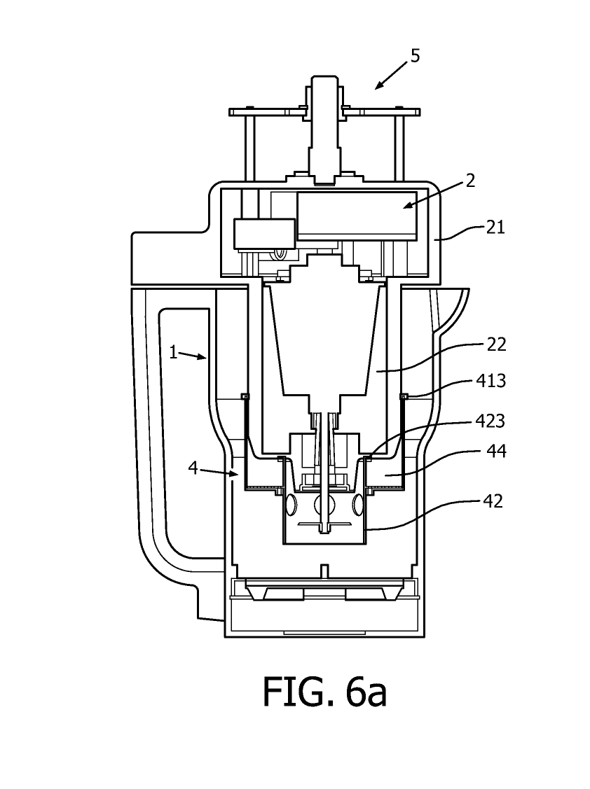

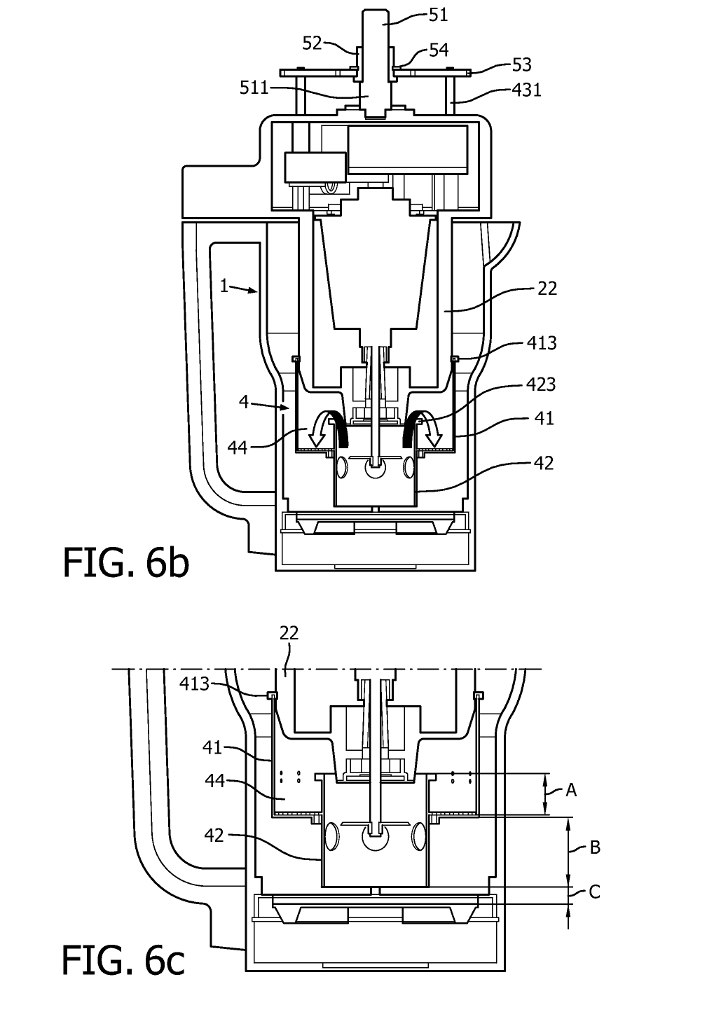

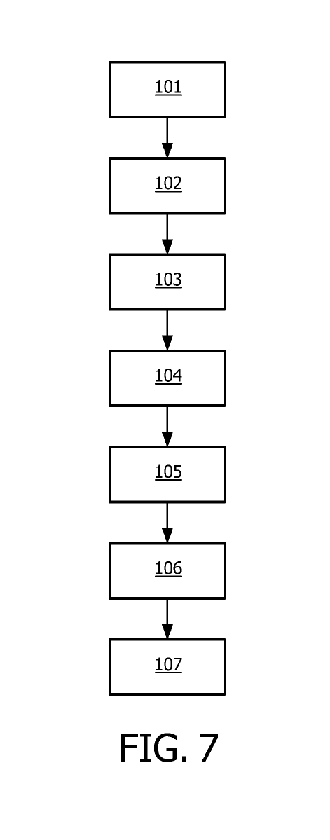

Reference is now made to FIGS. 3a-3b in conjunction with FIGS. 5a-5c, in which the collection unit 4 comprises a collection basket 41 for collecting testa and residue, and a guide cup 42 concentrically arranged at the bottom of the collection basket 41 for stirring the water or mixture in the container body 11. As can be seen from FIG. 6c, the guide cup 42 extends a first distance A above the bottom surface of the collection basket 41 so that a collection chamber 44 is formed between the guide cup 42 and the collection basket 41. Meanwhile, the guide cup 42 extends a second distance B beneath the bottom surface of the collection basket 41 and is spaced a third distance from the bottom of the container 1.

As shown in FIG. 5a, the collection basket 41 is cylindrically shaped, a filter 411 being provided at the bottom thereof for straining off the liquid from the testa and residue. Optionally, the filter 411 may also be provided on the side of the collection basket 41. It is noted that the filter 411 may be a separate element mounted onto the basket 41 or a screen net formed integrally with the basket 41, as long as a filtration function can be achieved. As indicated by FIG. 5b, the guide cup 42 has a cylindrical body with guide holes 421 therein, which allow unrestricted flow of the water or mixture inside and outside the guide cup. The guide holes 421 can be sized according to usual practice.

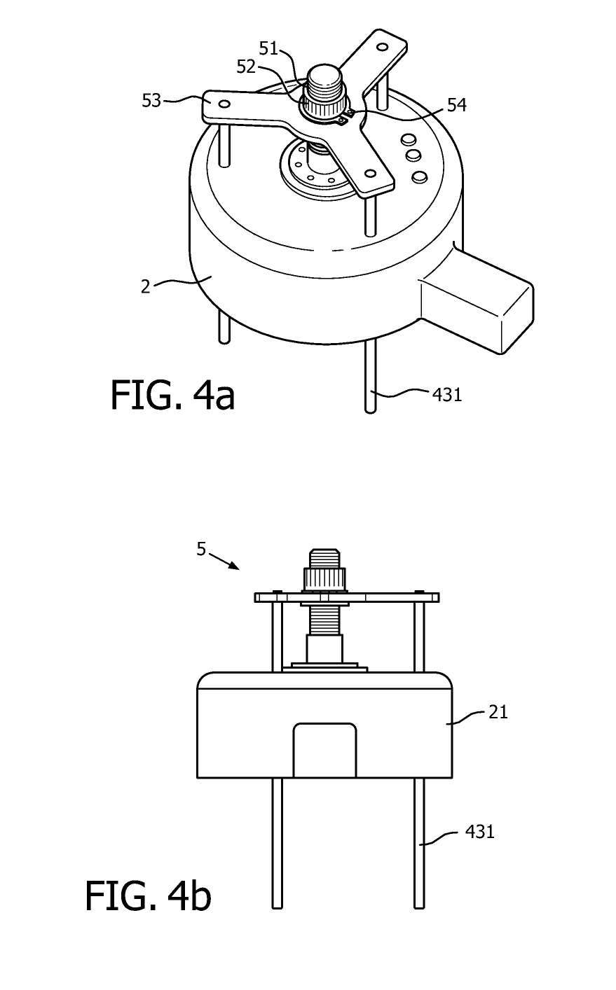

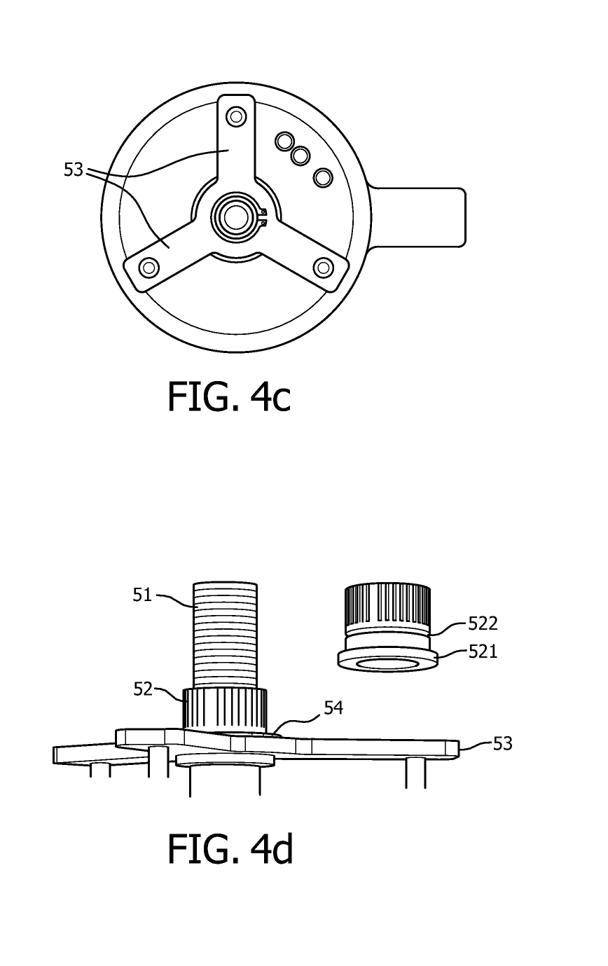

As best shown in FIG. 3b, the adjusting mechanism 5 comprises a threaded rod 51 mounted on the head cover 21 of the machine head 2 and extending upwards, a nut 52 engaging with the threaded rod 51, and a hand lever 53 detachably mounted on the nut 52. As shown in FIG. 4d, the nut 52 is provided with a base 521 at its bottom, so that the hand lever 53 can be seated thereon. Further, a ring-shaped groove 522 is formed in the central portion of the nut 52. When the hand lever 53 is mounted onto the nut 52 between the base 521 and the ring-shaped groove 522, a retaining spring 54 is attached to the nut 52 and received within the ring-shaped groove 522. As a result, the hand lever 53 is held in place and can be displaced with the nut 52 between a first position and a second position.

In this embodiment, a control unit (not shown), e.g. a MCU, is provided in the machine head for controlling the motor and accordingly the rotary cutter 3 driven by the motor. Thus, the grinding speed and grinding time of the rotary cutter 3 can be controlled by the control unit via the motor.

This control unit may further control a heater (not shown) so as to control the heating process during the production of the soymilk. It can also control the soaking time of the beans, etc. If desired, the control unit may also provide information to the user, such as giving an alarm to remind the user that a process (such as dehulling) is finished and the adjusting mechanism 5 should be operated to move the collection unit from one position (the first position or the second position) to the other position (the second position or the first position).

Referring to FIGS. 3a and 3b, in order to hold the collection unit 4 in place, a connector 43 (see FIG. 3b) is provided for connecting the collection basket 41 to the hand lever 53 of the adjusting mechanism 5. In this embodiment, the connector 43 comprises three hanger rods 431 which are fixed to three lugs 412 formed so as to be evenly distributed on the collection basket 41 along the periphery of the top end thereof. Meanwhile, the hanger rods 431 extend upward from the collection basket 41 and pass through corresponding holes 211 (see FIG. 3b) that are formed in the head cover 21 of the machine head 2 to connect to the adjusting mechanism 5. As a result, the collection unit 4 is suspended within the container, so that it can be moved between the first position where the beans are processed to separate testa or residue and the second position where testa or residue are collected in the collection unit 4. It is noted that, in order to allow the hanger rods to pass through the head cover 21, the corresponding through holes 211 (see FIG. 3b) are formed in the head cover 21 of the machine head 2 through which the hanger rods 431 pass so as to connect to the hand lever 53.

As best shown in FIG. 3b, the hand lever 53 correspondingly has three horizontal lever extensions 531, so that each of the hanger rods 431 is fixed at its top end to the corresponding lever extension 531 of the hand lever 53 by means of a through hole 532 formed in each of the lever extensions 531. Preferably, screws are used to fix the hanger rods 431 in the through hole 532 from the upper side of the hand lever 53. As an alternative, the through holes 532 may be threaded holes, and the top ends of the hanger rods 431 can be threaded (see FIG. 3b), so that the top end of the hanger rod 431 engages with the corresponding threaded through hole 532. Further, it is noted that, although three hanger rods are disclosed in this embodiment, the number of hanger rods 431 may be changed, and the number of lever extensions 531 may be changed in a corresponding manner. In addition, even though the connector 43 in this embodiment takes the form of hanger rods, it can take other forms such as hanger rings, and the hanger rods or hanger rings may for example be formed integrally with the collection basket 41.

Now, referring to FIG. 6a, the collection unit 4 is in the first position, namely the upper position. Correspondingly, the adjusting mechanism 5 is also in its first or upper position. It should be understood that the upper position is the so-called initial position of the soymilk maker, in which position beans can be processed in any way, but collection of testa or residue is not possible. That is, only when testa or residue is collected, the collection unit 4 is in the second position, being the lower position (see FIG. 6b). In this case, the adjusting mechanism 5 is in its second or lower position.

As indicated by FIG. 6a, the upper end of the guide cup 42 abuts against the lower end of head body 22 of the machine head 2 when the collection unit 4 is in the upper position, so that fluid communication between the collection chamber 44 and the container 1 via the guide cup 42 is prevented. A rubber seal 423 which is both water and soymilk proof is arranged at the top end of the guide cup 42 between the guide cup 42 and the head body 22 of the machine head 2. As a result, water or soymilk will never enter into the collection chamber 44 via the guide cup 42 in this case.

Next, referring to FIG. 6a-6c, specially to FIG. 6c, we can see that the upper end of collection basket 41 is an interference fit in the head body 22 of the machine head 2, irrespective of the position it is in (the upper position as shown in FIG. 6a or the lower position as shown in FIG. 6b or 6c), so that the testa or residue (if any) in the collection chamber 44 is prevented from spilling out and the water or soymilk in the container 1 is prevented from entering into the collection unit 4 from the upper end of the collection basket 41. It is noted that a rubber seal 413 is also arranged at the top end of the collection basket 41 to make sure that a water-resistant seal between the collection basket 41 and the side wall of the head body 22 of the machine head 2 is obtained.

When the testa separated from the bean or the residue need to be collected, the collection unit 4 will be moved from the upper position to the lower position by turning the nut 52 towards the bottom of the threaded rod 51. When the nut 52 is moved by the user with one hand, the hand lever 53 is moved downwards along with the nut 52, so that the hanger rods 431 force the collection basket 41 to move downwards. When the bottom of the nut 52 abuts against the top surface of a polished portion 511 of the threaded rod 51 (see FIG. 6b), the collection basket 41 will have reached the lower position. In this lower position, the top end of collection basket 41 is maintained in contact with the side wall of the head body 22 of the machine head 2, while the top end of the guide cup 42 is disengaged from the lower end of the head body 22 of the machine head 2 (see FIG. 6c). Thus, the testa or residue can be transferred from the container 1 to the collection chamber 44 of the collection unit 4 via the guide cup 42, as best shown in FIG. 6b.

When the soymilk is ready, the collection unit 4 is adjusted back to its initial position, being the upper position, by turning the nut 52 upwards. Before the collection unit 4 is cleaned, the top end of the hanger rods 431 is disengaged from the through holes 532 in the hand lever 5, so that the hanger rods 431 can be removed from the through holes 532 (see FIG. 3b) of the hand lever 53 and from the through holes 211 of the head cover 21 of the machine head 2. As a result, the collection unit 4 can be removed, so that the testa and residue can be cleared or rinsed out.

Next, a soymilk making process by means of the soymilk maker according to one preferred embodiment of the second aspect of the present invention will be described with reference to flowchart 7 comprising the following steps:
1): holding the collection unit 4 of the soymilk maker 100 in the upper position by operating the nut 52 of the adjusting mechanism 5 (if necessary) in step 101;
2): soaking the beans in water at a temperature of 90□ for 4 minutes in step 102;
3): dehulling the beans by grinding at a first medium speed to separate the testa from the cotyledons in step 103;
4): turning the nut 5 downwards and holding the collection unit 4 in the lower position, and subsequently collecting the testa in the collection chamber 44 by grinding at a second low speed in step 104;
5): turning the nut 5 upwards and holding the collection 4 in the upper position, and grinding at a third high speed to obtain soymilk in step 105;
6): heating the soymilk for one minute in step 106;
7): turning the nut 5 downwards and holding the collection unit 4 in the lower position, and then collecting the residue in the collection chamber 44 by grinding at a fourth low speed in step 107.

The soaking time and soaking temperature indicated in the present embodiment only are examples for achieving a good effect; they should not be construed as a limitation of the invention. It should be understood by a person skilled in the art that the soaking time is different for different soaking temperatures. For example, as far as soybeans are concerned, when the beans are soaked in hot water in the range of, for example, 45 to 90□, the required soaking time is in the range of 4 to 45 minutes (from about 4 min. in water of 90□ to about 45 min. in water of 45□). These parameters are not limited to the above-specified range; for example when water at room temperature or even lower is used, it is still possible to soak the beans at a temperature of the water above 90 degrees.

Experiments prove that dehulling improves residue reduction during the soymilk making process and causes more nutrition to be extracted into the soymilk. However, when dehulling is performed, the mixture of cotyledon and testa will stay mixed in the water. Since it is still difficult to thoroughly grind the testa into small pieces because of their elastic tissue, it is necessary for the testa to be collected before the residue can be collected.

It is noted that, dependent on different bean types, different soaking times or any other factors, it is possible to set different grinding speeds to achieve a high efficiency. The grinding speed for various conditions can be determined by experiments or tests. In this embodiment, the first medium grinding speed in step 103 may be 3800 rpm, the second low grinding speed in step 104 may be 600 rpm, the third high grinding speed in step 105 may be 15000 rpm, and the fourth low grinding speed in step 107 may be 600 rpm.

Those of ordinary skill in the art can understand and realize modifications to the disclosed embodiments, through studying the description, drawings and appended claims. All such modifications which do not depart from the spirit of the invention are intended to be included within the scope of the appended claims.

For example, it is possible to implement the invention in an embodiment in which the adjusting mechanism can take another form in that the nut 52 of the adjusting mechanism is replaced by a slide sleeve, and the thread of the threaded rod 51 of the adjusting mechanism is removed, so that the slide sleeve is mounted on a rod and can slide up and down along the rod. The adjusting mechanism may further comprise at least one cam which is arranged under the collection basket 41 of the collection unit 4 within the container 1. The cam(s) may be driven by a step motor causing the collection unit 4 of the soymilk maker 100 to move up and down between the above-mentioned two positions. That is, in steps 101 and 105, under the control of the MCB, the step motor drives the cam(s), causing them to rotate so that the lobes or high spots of the cam(s) come into contact with the collection basket 41 of the collection unit so as to lift it into the upper position and hold it there. In steps 104 and 107, the high spots of the cam(s) disengage from the bottom of collection basket 41 and the low spots of the cam(s) abut against it so that the collection unit 4 of the soymilk maker 100 is lowered and held in the lower position.

Other variations to the disclosed embodiments can be understood and effected by those skilled in the art in practicing the claimed invention, from a study of the drawings, the disclosure, and the appended claims. The word “comprising” or “comprise” does not exclude the presence of elements or steps not listed in a claim or in the description. The word “a” or “an” preceding an element does not exclude the presence of a plurality of such elements. In the claims, any reference signs placed between parentheses shall not be construed as limiting the claim.

1. A soymilk maker, comprising:
a container;
a machine head arranged on the upper portion of the container, the machine head having a motor accommodated therein;
a rotary cutter driven by the motor;
a collection unit arranged within the container for collecting testa and residue;
an adjusting mechanism being adjustable to enable the collection unit to move within the container between a first position where the beans are processed and a second position where the testa and residue are collected in the collection unit.

2. The soymilk maker of claim 1, wherein the collection unit further comprises a collection basket and a guide cup concentrically arranged at the bottom of the collection basket.

3. The soymilk maker of claim 2, wherein a connector is provided for connecting the collection basket to the adjusting mechanism through the machine head for suspending the collection basket within the container.

4. The soymilk maker of claim 3, wherein the connector comprises hanger rods extending upwards from the collection basket and through the machine head to connect to the adjusting mechanism.

5. The soymilk maker of claim 3, wherein the adjusting mechanism comprises a threaded rod attached onto the machine head and extending upwards, a nut engaging with the threaded rod, and a hand lever detachably mounted on the nut and linked with the connector.

6. The soymilk maker of claim 5, wherein the hanger rods comprise three hanger rods which are arranged uniformly along the periphery of the collection basket, and the hand lever correspondingly has three lever extensions, wherein each hanger rod is fixed at its top end to a corresponding lever extension of the hand lever.

7. The soymilk maker of claim 6, wherein the nut has a base at its bottom and a ring-shaped groove at its middle portion, and a retaining spring is received within the ring-shaped groove to hold the hand lever in place when the hand lever is mounted between the base and the ring-shaped groove of the nut.

8. The soymilk maker of claim 3, wherein the adjusting mechanism comprises a rod attached to the machine head and extending upwards, a slide sleeve mounted on the rod and being slidable along the rod, a hand lever detachably mounted on the slide sleeve and linked with the connector, and at least one cam arranged under the bottom of the collection basket within the container and driven by a second motor, so that the collection unit can move between the first position and the second position through rotation of the cam.

9. The soymilk maker of claim 1, wherein the guide cup extends a first distance A above the bottom surface of the collection basket, so that a collection chamber is formed between the guide cup and the collection basket.

10. The soymilk maker of claim 1, wherein the guide cup extends a second distance B beneath the bottom surface of the collection basket and is spaced a third distance C from the bottom of the container.

11. The soymilk maker of claim 9, wherein the upper end of the guide cup abuts against the lower end of the machine head when the collection unit is in the first position, so that fluid communication between the collection chamber and the container via the guide cup is prevented.

12. The soymilk maker of claim 11, wherein a rubber seal is arranged on the guide cup for forming a water-proof sealing between the guide cup and the machine head.

13. The soymilk maker of claim 1, wherein the upper end of the collection basket is an interference fit with the machine head, so that the testa or residue in the collection chamber is prevented from spilling out and the water or soymilk in the container is prevented from entering into the collection unit via the upper end of the collection basket.

14. The soymilk maker of claim 13, wherein a filter is provided on the bottom or side of the collection basket.

15. The soymilk maker of claim 1, wherein the machine head comprises a head cover for covering the container and a head body containing the motor.
